(19) United States
(12) Patent Application Publication
(10) Pub. No.: US 2023/0383136 A1
(43) Pub. Date: Nov. 30, 2023

(54) PAINT COMPOSITION CONTAINING BIO-RESIN WITH IMPROVED CHEMICAL RESISTANCE

(71) Applicants: HYUNDAI MOTOR COMPANY, Seoul (KR); KIA CORPORATION, Seoul (KR); KCC CORPORATION, Seoul (KR)

(72) Inventors: Ji Won Lee, Seoul (KR); Jung Woo Lee, Ulsan (KR); Ju Yeong Jeong, Busan (KR); Chi Uk Kim, Ulsan (KR); Soon Jong Park, Ulsan (KR)

(21) Appl. No.: 18/135,867

(22) Filed: Apr. 18, 2023

(30) Foreign Application Priority Data
May 24, 2022 (KR) 10-2022-0063158

(51) Int. Cl. C09D 133/08; C09D 7/40; C09D 5/00

(52) U.S. Cl. CPC C09D 133/08; C09D 7/40; C09D 5/00

(57) ABSTRACT

A paint composition contains bio-resin, which is eco-friendly and has improved chemical resistance that can impart excellent coating film physical properties, such as, adhesion, sun-cream resistance, chemical agent resistance, and fragrance resistance, by applying a bio-resin to the paint. The paint composition includes a bio-resin and an acrylic resin, and the bio-resin has a biocarbon content of 90 wt % or more as measured by ASTM D6866.

### CROSS REFERENCE TO RELATED APPLICATIONS

This application claims under 35 U.S.C. § 119(a) the benefit of priority to Korean Patent Application No. 10-2022-0063158 filed on May 24, 2022, the entire contents of which are incorporated herein by reference.

### BACKGROUND

### (a) Technical Field

The present disclosure relates to a paint composition, and more particularly, to a paint composition containing bio-resins, which is eco-friendly and has improved chemical resistance that can impart excellent coating film physical properties, such as, adhesion, sun-cream resistance, chemical agent resistance, and fragrance resistance, by applying the bio-resins to the paint.

### (b) Background Art

These days, regarding the growing concerns about the global environment, many efforts are being made in various fields to reduce carbon dioxide, which is pointed out as the main culprit of global warming. Therefore, bio-materials are spotlighted as a substitute for conventional petroleum and coal resources.

Bio materials do not increase the amount of carbon dioxide in the atmosphere because the sum of carbon dioxide emissions and absorption during the life cycle on the earth becomes zero. Besides, the bio materials may be an inevitable choice not only for environmental problems, but also for replacing depleted petroleum resources.

In particular, as the development of eco-friendly vehicles becomes more active, the demand for eco-friendly products applicable to vehicle interior materials is increasing. Meanwhile, paints for use in automobiles, to which a bio-resin is added, have the effect of reducing carbon dioxide emissions based on the entire process of paint production compared to paints using common petrochemical resins because bio materials are made of plants which use carbon dioxide in the atmosphere during their growth.

Therefore, in order to increase such effect, it is necessary to increase the content of the bio-resin in the paint, and however, the problem occurs in that as the content of the bio-paint composed of the ester type increases, the chemical resistance of the entire coating film is weakened.

On the other hand, conventionally, there is a method of forming a coating film by using starch as a resin component for a paint and curing the hydroxyl groups in the resin with a curing agent such as isocyanate. However, in this case, there is a problem in that the carboxyl group introduced for hydrophilization of the starch remains in the coating film, thereby reducing the water resistance of the coating film.

Additionally, in the case of a technique for synthesizing a polyurethane resin using rapeseed oil as biomass, there is a problem in that it is difficult to obtain paintability and physical properties required for automobile parts with the synthesized resin alone.

In addition, in the case of a technology for a method of using a urethane resin as a paint, which is synthesized using biomass, it has been applied to a paint for automobile interior parts, but limits to its application are becoming apparent as automotive interior parts require higher physical properties of the paint according to consumer demand.

Therefore, under the above background, it is necessary to develop a new paint composition that can provide the durable physical properties required for automobiles (chemical resistance, etc.) and increase the biocarbon content in a paint.

### SUMMARY

The present disclosure is to address the aforementioned problems, and an objective of the present disclosure is to provide a nature-friendly paint composition capable of increasing the biocarbon content in the paint while securing the durable physical properties required for automobiles.

Another objective of the present disclosure is to provide a paint composition to which a bio-resin is added, and which has excellent coating film physical properties such as adhesion, sun-cream resistance, chemical agent resistance and fragrance resistance.

The objectives of the present disclosure are not limited to the one mentioned above. The objective of the present disclosure will become more apparent by the following description, and will be realized by means and combinations thereof recited in the claims.

The paint composition according to the present disclosure includes a bio-resin and an acrylic resin, and the bio-resin has a biocarbon content of about 90 wt % or more as measured by ASTM D6866.

The paint composition may further include a solvent and an additive, and the paint composition may include about 5 to 11 wt % of the bio-resin, about 25 to 40 wt % of the acrylic resin, about 20 to 40 wt % of the solvent, and about 30 to 40 wt % of the additive.

The bio-resin may have a solid content of 90 to 100 wt %, a weight average molecular weight (Mw) of about 100 to 1000 g/mol, and a hydroxyl value of about 170 mg KOH/g or more.

The bio-resin may include at least one selected from the group consisting of poly lactic acid (PLA), poly butylene succinate (PBS), bio-polyethylene, a resin extracted from any one or more natural plants of corn, potato, sweet potato, sugarcane, bamboo, and other like varieties, poly-hydroxy alkanoate (PHA), and combinations thereof.

The acrylic resin may include a first acrylic resin, a second acrylic resin, and a third acrylic resin, wherein the first acrylic resin may have a solid content of about 57 to 59 wt %, a glass transition temperature (Tg) of about 25 to 35° C., a hydroxyl value of about 100 to 200 mg KOH/g, and a Gardner viscosity (25° C.) of Z to Z3, wherein the second acrylic resin may have a solid content of about 50 to 52 wt %, a glass transition temperature (Tg) of about 35 to 45° C., a hydroxyl value of about 50 to 100 mg KOH/g, and a Gardner viscosity (25° C.) of Y to Z2, and the third acrylic resin may have a solid content of about 50 to 52 wt %, a glass transition temperature (Tg) of about 45 to 55° C., a hydroxyl value of about 10 to 50 mg KOH/g, and a Gardner viscosity (25° C.) of Z2+ to Z4.

The acrylic resin may include, based on the total composition, about 10 to 15 wt % of the first acrylic resin; about 10 to 15 wt % of the second acrylic resin; and about 5 to 10 wt % of the third acrylic resin.

The solvent may include at least one selected from the group consisting of butyl acetate, methyl isobutyl ketone, and combinations thereof.

The additive may include at least one selected from the group consisting of matting agents, waxes, colorants, stain repellents, pot life delaying agents, curing accelerators, surface conditioning agents, dispersants, and combinations thereof.

The additive may include, based on the total composition, about 3 to 10 wt % of the matting agent, about 0.1 to 1 wt % of the wax, about 15 to 25 wt % of the colorant, about 0.5 to 3 wt % of the stain repellent, about 0.5 to 2 wt % of the pot life delaying agent, about 0.5 to 2 wt % of the curing accelerator, about 0.1 to 1 wt % of the surface conditioning agent, and about 0.1 to 1 wt % of the dispersant.

The paint composition may have a biocarbon content of about 14 to 23 wt % as measured by ASTM D6866.

According to the present disclosure, by applying a bio-resin to a paint, it is possible to prepare a paint composition with improved chemical resistance, which can be nature-friendly and impart excellent coating film physical properties, such as, adhesion, sun-cream resistance, chemical agent resistance, and fragrance resistance.

In addition, the paint composition according to the present disclosure can be used as a coating agent for nature-friendly automobile parts by increasing the biocarbon content in the paint by applying a high-purity bio-synthetic resin synthesized using an eco-friendly raw material extracted from a natural raw material (biomass) to the paint.

The effects of the present disclosure are not limited to the aforementioned effects. It should be understood that the effects of the present disclosure include all effects that can be inferred from the following description.

### DETAILED DESCRIPTION

The aforementioned objectives, other objectives, features and advantages of the present disclosure will be easily understood through the following preferred embodiments in conjunction with the accompanying drawings. However, the present disclosure is not limited to the embodiments described herein, but may be embodied in other forms. Rather, the embodiments introduced herein are provided so that the disclosed contents may be thorough and complete, and the technical idea of the present disclosure may be sufficiently conveyed to those skilled in the art.

The terms such as “include (or comprise)”, “have (or be provided with)”, and the like are intended to indicate that features, numbers, steps, operations, components, parts, or combinations thereof written in the following description exist, and thus should not be understood as that the possibility of existence or addition of one or more different features, numbers, steps, operations, components, parts, or combinations thereof is excluded in advance.

Unless otherwise specified, all numbers, values and/or expressions used herein to express quantities of ingredients, reaction conditions, polymer compositions and compounds are to be understood as being modified in all instances by the term “about”, since, among others, these numbers are essentially approximations which reflect the varying uncertainties of the measurements that take place in obtaining these values. Also, when numerical ranges are disclosed in this description, such ranges are continuous and include all values between the minimum and the maximum (inclusive) of the ranges, unless otherwise indicated. Furthermore, when such ranges refer to integers, all integers between the minimum and the maximum (inclusive) are included, unless otherwise indicated.

It should be understood that, in the specification, when the range is referred to regarding a variable, the variable encompasses all the values that lie within the range including disclosed end points. For example, it should be understood that the range of “5 to 10” includes values of 5, 6, 7, 8, 9, and 10, as well as arbitrary sub-ranges such as ranges of 6 to 10, 7 to 10, 6 to 9, and 7 to 9, and any values, such as 5.5, 6.5, 7.5, 5.5 to 8.5 and 6.5 to 9, between appropriate integers that fall within the range. In addition, for example, it should be understood that the range of “10% to 30%” encompasses all integers that include values such as 10%, 11%, 12%, 13%, and up to 30%, as well as any sub-ranges, such as ranges of 10% to 15%, 12% to 18%, or 20% to 30%, as well as any values, such as 10.5%, 15.5% and 25.5%, between appropriate integers that fall within the range.

Prior to describing the present disclosure, it may be helpful to note that “bio” refers to all living and recently killed biological matters excluding organic matters that have been converted through geological processes into a member selected from the group consisting of petroleum, petrochemicals, and combinations thereof.

The present disclosure relates to a paint composition containing a bio resin, which has improved chemical resistance, the paint composition including a bio-resin and an acrylic resin, wherein the bio-resin has a biocarbon content of 90 wt % or more as measured by ASTM D6866.

Specifically, the paint composition according to the present disclosure may further include a solvent and an additive, and the paint composition may include, based on the total composition, 5 to 11 wt % of the bio-resin, 25 to 40 wt % of the acrylic resin, 20 to 40 wt % of the solvent, and 30 to 40 wt % of the additive.

Each component constituting the paint composition according to the present disclosure will be described in more detail as follows.

### (A) Bio-Resin

The bio-resin is an eco-friendly raw material and is used to incorporate biocarbon into a paint composition. The bio-resin has a biocarbon content of 90 wt % or more as measured by ASTM D6866.

Here, the biocarbon content is measured using the radiocarbon analysis technique of the measurement method ASTM-D6866-12 (% Biobased Carbon Content). The biocarbon content can lead to accurate measurement of the biomass content through the experiment of ASTM D6866 standard. With the principle that radioactive carbon (C14), an isotope of carbon, is present in biomass materials, while petrochemical polyethylene does not have C14 at all, the content of renewable carbon in the film can be calculated based on the total carbon.

The bio-resin may be included in an amount of 5 to 11 wt % in the paint composition. The paint composition which has the content of bio-resin less than 5 wt % is not suitable for use as an eco-friendly paint due to the low biocarbon content, and the paint composition which has the content of bio-resin greater than 11 wt % may have a problem of lowering sun-cream resistance and fragrance resistance.

The bio-resin according to the present disclosure may be in an emulsion state in which is a mixture of a water-incompatible material (solid or liquid) and water. The bio-resin may have a solid solid content of 90 to 100 wt % in the emulsion state.

Additionally, the bio-resin in the emulsion state may include, as a solid, at least one selected from the group consisting of poly lactic acid (PLA), poly butylene succinate (PBS), bio-polyethylene, a resin extracted from any one or more natural plants of corn, potato, sweet potato, sugarcane, bamboo, and other like varieties, poly-hydroxy alkanoate (PHA) and combinations thereof.

The bio-resin may have a solid content of 90 to 100 wt %, a weight average molecular weight (Mw) of 100 to 1000 g/mol, and a hydroxyl value of 170 mg KOH/g or more. Specifically, the solid content of the bio-resin may be 90 to 100 wt %. When the solid content of the bio-resin is within the above range, spray workability of the corresponding paint may be excellent. When the solid content of the bio-resin is less than the above range, the content of the resin in the paint decreases, and thus a coating film may not be properly formed, so that its mechanical-physical properties may be deteriorated.

Specifically, the bio-resin may have a weight average molecular weight (Mw) of 100 to 1,000 g/mol, and a hydroxyl value of 170 mg KOH/g or more, or, in another example, 170 to 270 mg KOH/g. When the weight average molecular weight and hydroxyl value of the bio-resin are within the above ranges, a coating film may be well formed and its mechanical-physical properties may be excellent. When the weight average molecular weight and hydroxyl value of the bio-resin are less than the above ranges, compatibility with other raw materials such as additives and the like decreases, so that workability may be deteriorated. And when the range of the weight average molecular weight exceeds the above range, the viscosity increases, so that workability may be deteriorated.

### (B) Acrylic Resin

The acrylic resin may be used which has been directly synthesized according to a known method, or which is a commercially available product. In this regard, the acrylic resin may be prepared, for example, by polymerizing vinyl monomers. The vinyl monomer may be, for example, (meth)acrylate substituted or unsubstituted with a hydroxyl group, and, specifically, may include one or more kinds selected from the group consisting of (meth)acrylic acid, methyl (meth)acrylic acid, methyl (meth)acrylate, ethyl (meth)acrylate, isobutyl (meth)acrylate, n-butyl (meth)acrylate, t-butyl (meth)acrylate, n-hexyl (meth)acrylate, cyclohexyl (meth)acrylate, 2-ethylhexyl (meth)acrylate, n-octyl (meth)acrylate, isobornyl (meth)acrylate, styrene, methylstyrene, dimethylstyrene, fluorostyrene, ethoxystyrene and methoxystyrene.

The acrylic resin may be included in an amount of 25 to 40 wt % in the paint composition. In this regard, when the content of the acrylic resin is out of the aforementioned content range, it may be difficult to implement the physical properties of the coating film such as the sun-cream resistance, the fragrance resistance and the like as in the present disclosure.

The acrylic resin according to the present disclosure may be in an emulsion state in which is a mixture of a water-incompatible material (solid or liquid) and water, and may be a mixture of acrylic resins having different glass transition temperatures. When a material with a low glass transition temperature is applied alone and exposed to high heat, it is unstable to heat, so that the heat resistance of the coating film may be lowered. And, when a material with a high glass transition temperature is applied alone, the coating film is hard, so that it can be easily broken by external stimuli. Accordingly, when a mixture of materials having different glass transition temperatures is applied, heat resistance can be excellent and the coating film can be prevented from being broken by external stimuli.

The acrylic resin may include a first acrylic resin, a second acrylic resin, and a third acrylic resin.

The first acrylic resin may be included in an amount of 10 to 15 wt % based on the total composition. The first acrylic resin may have a solid content of 57 to 59 wt % in the emulsion state.

The first acrylic resin may have a glass transition temperature (Tg) of 25 to 35° C., a hydroxyl value of 100 to 200 mg KOH/g, and a Gardner viscosity (25° C.) of Z to Z3.

Specifically, the first acrylic resin may have a glass transition temperature (Tg) of to 35° C., and a hydroxyl value of 100 to 200 mg KOH/g. When the glass transition temperature and hydroxyl value of the first acrylic resin are within the above ranges, the coating film can be soft and compatibility with other materials can be excellent. When the glass transition temperature and the hydroxyl value of the first acrylic resin are less than the above ranges, the coating film is be too soft, so that hardness may be lowered. And when they exceed the above ranges, compatibility with other materials is lowered, so that appearance may be deteriorated.

The second acrylic resin may be included in an amount of 10 to 15 wt % based on the total composition. The second acrylic resin may have a solid content of 50 to 52 wt % in the emulsion state.

The second acrylic resin may have a glass transition temperature (Tg) of 35 to a hydroxyl value of 50 to 100 mg KOH/g, and a Gardner viscosity (25° C.) of Y to Z2.

Specifically, the second acrylic resin may have a glass transition temperature (Tg) of 35 to 45° C., and a hydroxyl value of 50 to 100 mg KOH/g. When the glass transition temperature and hydroxyl value of the second acrylic resin are within the above ranges, an appropriate cross-linking can be formed with the curing agent, so that adhesion can be excellent. When the glass transition temperature and hydroxyl value of the second acrylic resin are less than the above ranges, curing is not done properly, so that adhesion may be lowered. And when they exceed the above ranges, the coating film may be easily broken due to overcuring.

The third acrylic resin may be included in an amount of 5 to 10 wt % based on the total composition. The third acrylic resin may have a solid content of 50 to 52 wt % in the emulsion state.

The third acrylic resin may have a glass transition temperature (Tg) of 45 to 55° C., a hydroxyl value of 10 to 50 mg KOH/g, and a Gardner viscosity (25° C.) of Z2+ to Z4.

Specifically, the third acrylic resin may have a glass transition temperature (Tg) of 35 to 45° C., and a hydroxyl value of 50 to 100 mg KOH/g. When the glass transition temperature and hydroxyl value of the third acrylic resin are within the above ranges, the coating film can be hard, so that hardness can be excellent. When the glass transition temperature and the hydroxyl value of the third acrylic resin are less than the above ranges, the coating film is soft, so that hardness may be lowered. And when they exceed the above ranges, the coating film becomes too hard, so that it can be easily broken by external stimuli.

### (C) Solvent

The solvent serves to control the thickness of the coating film and improve the coating film workability of the composition. The solvent is included in an amount of 20 to 40 wt % in the paint composition, and specifically, the solvent may include at least one selected from the group consisting of butyl acetate, methyl isobutyl ketone, and combinations thereof.

### (D) Additive

The additive is a composition for imparting various functionalities to the paint composition, and a known additive may be used without any particular limitation as long as the additive does not deteriorate the effects of the present disclosure.

Specifically, the additive may be included in an amount of 30 to 40 wt % in the paint composition according to the present disclosure.

The additive may include at least one selected from the group consisting of matting agents, waxes, colorants, stain repellents, pot life delaying agents, curing accelerators, surface conditioning agents, dispersants, and combinations thereof.

The additive may include, based on the total composition, 3 to 10 wt % of the matting agent, 0.1 to 1 wt % of the wax, 15 to 25 wt % of the colorant, 1 to 3 wt % of the wax, 0.5 to 3 wt % of the stain repellent, 0.5 to 2 wt % of the pot life delaying agent, 0.5 to 2 wt % of the curing accelerator, 0.1 to 1 wt % of the surface conditioning agent, and 0.1 to 1 wt % of the dispersant.

The paint composition according to the present disclosure may have a biocarbon content of 14 to 23 wt % as measured by ASTM D6866.

Meanwhile, it should be understood that the paint composition according to the present disclosure is not limited in its field of use, and can be used as a coating material for automobile parts. Specifically, it can be applied as a coating film matt coating agent to various materials in automobiles, which require excellent coating film physical properties such as adhesion, sun-cream resistance, chemical resistance, fragrance resistance and the like.

Hereinafter, the present disclosure will be described in more detail through specific examples. The following examples are merely examples to help the understanding of the present disclosure, and the scope of the present disclosure is not limited thereto.

### Examples and Comparative Examples

First, the main materials of the paint composition were prepared with the compositions and contents described in Tables 1 and 2 below.

TABLE 1

| Component | | | | | |
|---|---|---|---|---|---|
| (wt %) | | Example 1 | Example 2 | Example 3 | Example 4 |
| Bio resin | High-purity bio resin | 5 | 7 | 9 | 11 |
| | Low-purity bio resin | — | — | — | — |
| Acrylic resin | First acrylic resin | 14 | 14 | 14 | 14 |
| | Second acrylic resin | 11 | 11 | 11 | 11 |
| | Third acrylic resin | 5 | 5 | 5 | 5 |
| Additive | Matting agent | 6.5 | 6.5 | 6.5 | 6.5 |
| | Wax | 0.5 | 0.5 | 0.5 | 0.5 |
| | Colorant | 22 | 22 | 22 | 22 |
| | Stain repellent | 2 | 2 | 2 | 2 |
| | Pot life delaying | 1.2 | 1.2 | 1.2 | 1.2 |
| | agent | | | | |
| | Curing accelerator | 1 | 1 | 1 | 1 |
| | Surface conditioning | 0.5 | 0.5 | 0.5 | 0.5 |
| | agent | | | | |
| | Dispersant | 0.5 | 0.5 | 0.5 | 0.5 |
| Solvent | | 30.8 | 28.8 | 26.8 | 24.8 |
| Total | | 100 | 100 | 100 | 100 |

1. Bio resin
High-purity bio resin: solid content: 100% , biocarbon content: 100%, MW: 540 g/mol, OH value: 206,
2. Acrylic resin
First acrylic resin: solid content: 57-59 wt %, OHv: 139 mgKOH/g, Tg: 32° C., viscosity at 25° C.: Z~Z3
Second acrylic resin: solid content: 50-52 wt %, OHv: 66 mgKOH/g, Tg: 41° C., viscosity at 25° C.: Y~Z2
Third acrylic resin: solid content: 50-52 wt %, OHv: 40 mgKOH/g, Tg: 50° C., viscosity at 25° C.: Z2+~Z4
3. Additive
Matting agent: TOSOH company, NILSIL E-220A product
Wax: HUNGSAN HWASUNG, HPA-405 product
Colorant: KCC company, YX1234K product
Stain repellent: EVONIK company, AEROSIL R-972 product
Pot life delaying agent: glycol di(3-mercaptopropionate)
Curing accelerator: dibutyltindilaurate (DBTDL)
Surface conditioning agent
Dispersant
4. Solvent: butyl acetate, methyl isobutyl ketone

TABLE 2

| Component | | Comparative | Comparative | Comparative | Comparative | Comparative | Comparative |
|---|---|---|---|---|---|---|---|
| (wt %) | | Example 1 | Example 2 | Example 3 | Example 4 | Example 5 | Example 6 |
| Bio resin | High-purity | — | — | — | — | 13 | 2 |
| | bio resin | | | | | | |
| | Low-purity | — | 5 | 7 | 9 | — | — |
| | bio resin | | | | | | |
| Acrylic | First acrylic | 14 | 14 | 14 | 14 | 14 | 14 |
| resin | resin | | | | | | |
| | Second | 11 | 11 | 11 | 11 | 11 | 11 |
| | acrylic resin | | | | | | |
| | Third | 5 | 5 | 5 | 5 | 5 | 5 |
| | acrylic resin | | | | | | |
| Additive | Matting | 6.5 | 6.5 | 6.5 | 6.5 | 6.5 | 6.5 |
| | agent | | | | | | |
| | Wax | 0.5 | 0.5 | 0.5 | 0.5 | 0.5 | 0.5 |
| | Colorant | 22 | 22 | 22 | 22 | 22 | 22 |
| | Stain | 2 | 2 | 2 | 2 | 2 | 2 |
| | repellent | | | | | | |
| | Pot life | 1.2 | 1.2 | 1.2 | 1.2 | 1.2 | 1.2 |
| | delaying | | | | | | |
| | agent | | | | | | |
| | Curing | 1 | 1 | 1 | 1 | 1 | 1 |
| | accelerator | | | | | | |
| | Surface | 0.5 | 0.5 | 0.5 | 0.5 | 0.5 | 0.5 |
| | conditioning | | | | | | |
| | agent | | | | | | |
| | Dispersant | 0.5 | 0.5 | 0.5 | 0.5 | 0.5 | 0.5 |
| Solvent | | 35.8 | 30.8 | 28.8 | 26.8 | 22.8 | 33.8 |
| Total | | 100 | 100 | 100 | 100 | 100 | 100 |

1. Bio resin
High-purity bio resin: solid content: 100%, biocarbon content: 100%, MW: 540 g/mol, OH value: 206,
Low-purity bio resin: solid content: 100%, biocarbon content: 48%, MW: 2000 g/mol, OH value: 56
2. Acrylic resin
First acrylic resin: solid content: 57-59 wt %, OHv: 139 mgKOH/g, Tg: 32° C., viscosity at 25° C.: Z~Z3
Second acrylic resin: solid content: 50-52 wt %, OHv: 66 mgKOH/g, Tg: 41° C., viscosity at 25° C.: Y~Z2
Third acrylic resin: solid content: 50-52 wt %, OHv: 40 mgKOH/g, Tg: 50° C., viscosity at 25° C.: Z2+~Z4
3. Additive
Matting agent: TOSOH company, NILSIL E-220A product
Wax: HUNGSAN HWASUNG, HPA-405 product
Colorant: KCC company, YX1234K product
Stain repellent: EVONIK company, AEROSIL R-972 product
Pot life delaying agent: glycol di(3-mercaptopropionate)
Curing accelerator: dibutyltindilaurate (DBTDL)
Surface conditioning agent
Dispersant
4. Solvent: butyl acetate, methyl isobutyl ketone

### Experimental Example

A paint composition having a viscosity of 13 to 14 seconds measured by a Podcup #4 viscometer at 25° C. was prepared by mixing the main agents prepared in Examples 1 to 4 and Comparative Examples 1 to 6 with a polyisocyanate-based curing agent, and diluting it with a diluting thinner.

Then, an ABS material was painted with the paint composition (dried coating film thickness: 17-23 μm) and the paint composition was dried for 30 minutes to form a coating film.

Thereafter, the physical properties of the coating film as described above were evaluated in the following manner, and the results are shown in Table 3 below. At this time, excellent is indicated by ⊚, good is indicated by ∘, normal is indicated by Δ, and poor is indicated by X.

### Performance Evaluation Method

(1) Adhesion: The adhesion of the final coating film was evaluated by the number of peeled parts among 100 scales of 1 mm×1 mm (width×length) size according to ASTM D3359 tape adhesion test method. The test was performed repeatedly 6 times, and when passed 6 times, it was evaluated as excellent, when it passed 5 times, it was evaluated as good, when it passed 3 and 4 times, it was evaluated as normal, and when it passed 3 times or less, it was evaluated as poor. At this time, the criterion for the pass was that the adhesion was M2.5 or more based on the standards described in ISO 2409.

(2) Sun-cream resistance: After stacking 2 sheets of white cotton cloth (equivalent to Toyosynthetic CH2070-3) of the same size on an acrylic plate (50 mm×50 mm, horizontal×vertical), 0.25 g of sun cream (Nivea SPF47) was applied on the entire surface. After that, the sun cream application site was placed on the coating film and the acrylic plate was pressed to bring them into close contact. Thereafter, it was left in a constant-temperature bath at for 1 hour, then taken out, and the white cotton cloth and acrylic plate were removed, and then left at room temperature for 10 minutes. After this, the coating film was washed with a neutral detergent and dried, and the adhesion of the coating film was evaluated.

(3) Chemical agent resistance: A weight of 4.9N was wrapped with gauze, and after being sufficiently wetted with a prescribed chemical, the surface of the coating film was rubbed reciprocatingly 10 times, and the outer appearance was inspected with the naked eye. Thereafter, it was left at room temperature for 1 hour, was left for 3 hours in a constant temperature chamber under 80±2° C. condition, and then the surface condition of the coating film was inspected. (evaluation criteria confirmed that there was no discoloration, fading, swelling, cracking, adherend exposure, and the like in the coating film. (1) Gray Scale Inspection)

(4) Fragrance resistance: After attaching an aluminum cap having a diameter of 20 mm to the surface of the coating film using an adhesive, 0.2 ml of the fragrance evaluation liquid was dropped into the aluminum cap using a dropping pipette, and it was left at room temperature for 5 minutes. Then, after leaving it in the constant-temperature bath at 70±2° C. for 30 minutes, it was taken out. Next, after removing the attached aluminum cap, the surface of the coating film was inspected with the naked eye.

(5) Biocarbon content: The bio content evaluation is a value measured according to ASTM D 6866 Method B or ASTM D 6866 Method C after preparing a coating film that complies with the prescribed coating film thickness and drying conditions (80° C., 30 minutes). Here, ASTM D6866 measures the bio content by detecting C14, which is not present in petroleum origin.

TABLE 3

| Physical | | | | | | | | | | |
|---|---|---|---|---|---|---|---|---|---|---|
| property | Example | Example | Example | Example | Comparative | Comparative | Comparative | Comparative | Comparative | Comparative |
| evaluation | 1 | 2 | 3 | 4 | Example 1 | Example 2 | Example 3 | Example 4 | Example 5 | Example 6 |
| (1) | ⊚ | ⊚ | ⊚ | ⊚ | ⊚ | ⊚ | ⊚ | ⊚ | ⊚ | ⊚ |
| Adhesion | | | | | | | | | | |
| (2) Sun- | ⊚ | ⊚ | ◯ | ◯ | ⊚ | ◯ | ◯ | ◯ | Δ | ⊚ |
| cream | | | | | | | | | | |
| resistance | | | | | | | | | | |
| (3) | ⊚ | ⊚ | ⊚ | ⊚ | ⊚ | ⊚ | ⊚ | ◯ | ◯ | ⊚ |
| Chemical | | | | | | | | | | |
| agent | | | | | | | | | | |
| resistance | | | | | | | | | | |
| (4) | ⊚ | ⊚ | ◯ | ◯ | ⊚ | ◯ | Δ | X | X | ⊚ |
| Fragrance | | | | | | | | | | |
| resistance | | | | | | | | | | |
| (5) | ◯ | ⊚ | ⊚ | ⊚ | X | X | X | Δ | ⊚ | X |
| Biocarbon | (14 | (17 | (20 | (23 | (0 | (7 | (8.5 | (10 | (26 | (9.5 |
| content | wt %) | wt %) | wt %) | wt %) | wt %)) | wt %) | wt %) | wt %) | wt %) | wt %) |

Referring to the results in Table 3, it was confirmed that the paint compositions according to Examples 1 to 4 had a biocarbon content of 14 to 23 wt %, so that they could be used as an eco-friendly paint with a high biocarbon content. Additionally, it can be seen that the paints of Examples 1 to 4 were generally excellent in physical properties such as adhesion, sun-cream resistance, chemical agent resistance and fragrance resistance, and that Comparative Examples 1 to 6 were poor in physical properties compared to Examples.

In Comparative Example 1 using only the components of the conventional general matt paint, the biocarbon content was not measured at all.

In addition, Comparative Examples 2 to 4, in which a low-purity bio-resin was used in an amount of 5 to 11 wt % in the general matt paint component, were measured to have a small amount of biocarbon content, which was, however, significantly lower than those of Examples, and their results showed that they did not satisfy the requirement of the fragrance resistance which is basically required for paints.

Also, Comparative Example 5, in which the high-purity bio-resin was used in excess of 11 wt % in the general matt paint component, was measured to have a high biocarbon content, so it may be used as a nature-friendly paint, and however, its results showed that it did not satisfy the requirements for sun-cream resistance and fragrance resistance, which are basically required for paints.

Additionally, Comparative Example 6, in which the high-purity bio-resin was used in an amount of less than 5 wt % in the general matt paint component, was measured to have the relatively low biocarbon content compared to those of Examples.

Therefore, it can be seen that the paint composition according to the present disclosure is excellent in quality with all properties balanced by including respective components in their proper contents.

Therefore, the present disclosure can prepare a paint composition with improved chemical resistance, which can be nature-friendly and impart excellent coating film physical properties, such as, adhesion, sun-cream resistance, chemical resistance, and fragrance agent resistance, by applying a high-purity bio-resin in a proper amount.

While the embodiments of the present disclosure have been described above, those of ordinary skill in the art to which the present disclosure pertains will appreciate that the present disclosure may be implemented in other specific forms without changing the technical idea or essential features thereof. Accordingly, it should be understood that the embodiments described above are illustrative in all respects and not restrictive.

1. A paint composition comprising:
a bio-resin; and
an acrylic resin;
wherein the bio-resin has a biocarbon content of about 90 wt % or more as measured by ASTM D6866.

2. The paint composition of claim 1,
wherein the paint composition further comprises a solvent and an additive;
wherein the paint composition comprises:
an amount of about 5 to 11 wt % of the bio-resin;
an amount of about 25 to 40 wt % of the acrylic resin;
an amount of about 20 to 40 wt % of the solvent; and
an amount of about 30 to 40 wt % of the additive.

3. The paint composition of claim 1,
wherein the bio-resin has a solid content of about 90 to 100 wt %, a weight average molecular weight (Mw) of about 100 to 1000 g/mol, and a hydroxyl value of about 170 mg KOH/g or more.

4. The paint composition of claim 1,
wherein the bio-resin includes at least one of poly lactic acid (PLA), poly butylene succinate (PBS), bio-polyethylene, a resin extracted from any one or more natural plants of corn, potato, sweet potato, sugarcane, bamboo, and other like varieties, poly-hydroxy alkanoate (PHA), or any combination thereof.

5. The paint composition of claim 1,
wherein the acrylic resin comprises a first acrylic resin, a second acrylic resin, and a third acrylic resin;
wherein the first acrylic resin has a solid content of about 57 to 59 wt %, a glass transition temperature (Tg) of about 25 to 35° C., a hydroxyl value of about 100 to 200 mg KOH/g, and a Gardner viscosity (25° C.) of Z to Z3;
wherein the second acrylic resin has a solid content of about 50 to 52 wt %, a glass transition temperature (Tg) of about 35 to 45° C., a hydroxyl value of about 50 to 100 mg KOH/g, and a Gardner viscosity (25° C.) of Y to Z2; and
wherein the third acrylic resin has a solid content of about 50 to 52 wt %, a glass transition temperature (Tg) of about 45 to 55° C., a hydroxyl value of about 10 to 50 mg KOH/g, and a Gardner viscosity (25° C.) of Z2+ to Z4.

6. The paint composition of claim 5,
wherein the acrylic resin comprises, based on the total weight of the paint composition:
an amount of about 10 to 15 wt % of the first acrylic resin;
an amount of about 10 to 15 wt % of the second acrylic resin; and
an amount of about 5 to 10 wt % of the third acrylic resin.

7. The paint composition of claim 2,
wherein the solvent comprises at least one of butyl acetate, methyl isobutyl ketone, or any combination thereof.

8. The paint composition of claim 2,
wherein the additive comprises at least one of matting agents, waxes, colorants, stain repellents, pot life delaying agents, curing accelerators, surface conditioning agents, dispersants, or any combination thereof.

9. The paint composition of claim 8,
wherein the additive comprises, based on the total weight of the paint composition:
an amount of about 3 to 10 wt % of the matting agent;
an amount of about 0.1 to 1 wt % of the wax;
an amount of about 15 to 25 wt % of the colorant;
an amount of about 0.5 to 3 wt % of the stain repellent;
an amount of about 0.5 to 2 wt % of the pot life delaying agent;
an amount of about 0.5 to 2 wt % of the curing accelerator;
an amount of about 0.1 to 1 wt % of the surface conditioning agent; and
an amount of about 0.1 to 1 wt % of the dispersant.

10. The paint composition of claim 1,
wherein the paint composition has a biocarbon content of about 14 to 23 wt % as measured by ASTM D6866.
